(19) United States
(12) Patent Application Publication
(10) Pub. No.: US 2024/0323953 A1
(43) Pub. Date: Sep. 26, 2024

(54) METHOD, DEVICE AND COMPUTER READABLE MEDIUM FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 18/290,119

(22) PCT Filed: May 19, 2021
(86) PCT No.: PCT/CN2021/094723

§ 371 Date: Nov. 9, 2023

(51) Int. Cl. H04W 72/1268; H04L 1/1867; H04L 5/00

(52) U.S. Cl. CPC H04W 72/1268; H04L 1/189; H04L 5/0051

(57) ABSTRACT

Embodiments of the present disclosure relate to methods, devices and computer readable media for communication. According to embodiments of the present disclosure, a terminal device receives, from a network device, a radio resource control (RRC) configuration comprising a repetition number for physical uplink shared channel (PUSCH) transmission occasions associated with a first sounding reference signal (SRS) resource indicator (SRI) and PUSCH transmission occasions associated with a second SRI, the RRC configuration further comprising a redundancy version (RV) offset to a RV sequence associated with the first SRI. The terminal device receives DCI indicating an identity of a RV. If a first RV sequence determined based on the repetition number, the identity and the RV offset meets a condition, the terminal device does not apply the first RV sequence. In this way, it improves reliability.

### TECHNICAL FIELD

Embodiments of the present disclosure generally relate to the field of telecommunication, and in particular, to methods, devices and computer storage media for communication.

### BACKGROUND

Technology of multiple input multiple output (MIMO) has been widely used in current wireless communication system, where of a large number of antenna elements are used by a network device for communicating with a terminal device. Further, in order to improve the reliability and robustness of the communication between the network device and the terminal device, technology of multi-Transmission and Reception Point (multi-TRP) (as well as multi-panel reception) has been proposed and discussed recently. Generally speaking, downlink control information (DCI) may be used by the network device to indicate the scheduling information to the terminal device. Some proposals about the DCI for enabling multi-TRP and/or multi-panel have been discussed and some agreements have been reached.

### SUMMARY

In general, embodiments of the present disclosure provide methods, devices and computer storage media for redundancy version determination.

In a first aspect, there is provided a method of communication. The method comprises: receiving, at a terminal device and from a network device, a radio resource control (RRC) configuration comprising a repetition number for physical uplink shared channel (PUSCH) transmission occasions associated with a first sounding reference signal (SRS) resource indicator (SRI) and PUSCH transmission occasions associated with a second SRI, the RRC configuration further comprising a redundancy version (RV) offset to a RV sequence associated with the first SRI: receiving, from the network device, downlink control information (DCI) indicating an identity of a RV: determining whether a first RV sequence for the PUSCH transmission occasions associated with the second SRI meets conditions of repetition transmissions for the PUSCH transmission occasions associated with the second SRI, the first RV sequence being determined based on the repetition number, the identity and the RV offset; and in accordance with a determination that the first RV sequence meets the conditions, transmitting, to the network device, uplink data on the PUSCH transmission occasions associated with the second SRI without applying the first RV sequence.

In a second aspect, there is provided a method of communication. The method comprises: receiving, at a terminal device and from a network device, a radio resource control (RRC) configuration comprising: a repetition number for repetition transmissions of physical uplink shared channel (PUSCH) transmission occasions associated with a first sounding reference signal (SRS) resource indicator (SRI) and PUSCH transmission occasions associated with a second SRI, a set of configured grant parameters, and an indication to enable an initial transmission associated with the second SRI: in accordance with a determination that a PUSCH transmission occasion satisfies a condition, transmitting, to the network device, the initial transmission.

In a third aspect, there is provided a method of communication. The method comprises: transmitting, at a network device and to a terminal device, a radio resource control (RRC) configuration comprising a repetition number for physical uplink shared channel (PUSCH) transmission occasions associated with a first sounding reference signal (SRS) resource indicator (SRI) and PUSCH transmission occasions associated with a second SRI, the RRC configuration further comprising a redundancy version (RV) offset to a RV sequence associated with the first SRI, and a redundancy version (RV) offset to a RV sequence associated with the first SRI; transmitting, to the terminal device, downlink control information (DCI) indicating an identity of a RV; and in accordance with a determination that a first RV sequence determined based on the repetition number and the identity meets conditions of repetition transmissions for the PUSCH transmission occasions associated with the second SRI, receiving, from the terminal device, uplink data on the PUSCH transmission occasions associated with the second SRI without applying the first RV sequence.

In a fourth aspect, there is provided a method of communication. The method comprises: transmitting, at a network device and to a terminal device, a radio resource control (RRC) configuration comprising: a repetition number for physical uplink shared channel (PUSCH) transmission occasions associated with a first sounding reference signal (SRS) resource indicator (SRI) and PUSCH transmission occasions associated with a second SRI, a set of configured grant parameters, and an indication to enable an initial transmission associated with the second SRI: in accordance with a determination that a PUSCH transmission occasion satisfies a condition, receiving, from the terminal device, the initial transmission.

In a fifth aspect, there is provided a terminal device. The terminal device comprises a processor and a memory coupled to the processor. The memory stores instructions that when executed by the processor, cause the terminal device to perform the method according to the first aspect of the present disclosure.

In a sixth aspect, there is provided a terminal device. The terminal device comprises a processor and a memory coupled to the processor. The memory stores instructions that when executed by the processor, cause the terminal device to perform the method according to the second aspect of the present disclosure.

In a seventh aspect, there is provided a network device. The network device comprises a processor and a memory coupled to the processor. The memory stores instructions that when executed by the processor, cause the network to perform the method according to the third aspect of the present disclosure.

In an eighth aspect, there is provided a network device. The network device comprises a processor and a memory coupled to the processor. The memory stores instructions that when executed by the processor, cause the network device to perform the method according to the fourth aspect of the present disclosure.

In a ninth aspect, there is provided a computer readable medium having instructions stored thereon. The instructions, when executed on at least one processor, cause the at least one processor to perform the method according to the first, second, third or fourth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIGS. 1A and 1B illustrate schematic diagrams of configured grant (CG) resources:

FIGS. 2A and 2B illustrate an example communication network in which embodiments of the present disclosure can be implemented:

FIG. 3 illustrates a signaling flow for communication according to some example embodiments of the present disclosure:

FIG. 4 illustrates a signaling flow for communication according to some example embodiments of the present disclosure:

FIG. 5 illustrates a schematic diagram of an example of circular buffer for incremental redundancy in accordance with some embodiments of the present disclosure:

FIG. 6 illustrates a flow chart of an example method of communication implemented at a terminal device in accordance with some embodiments of the present disclosure:

FIG. 7 illustrates a flow chart of an example method of communication implemented at a terminal device in accordance with some embodiments of the present disclosure;

FIG. 8 illustrates a flow chart of an example method of communication implemented at a network device in accordance with some embodiments of the present disclosure:

FIG. 9 illustrates a flow chart of an example method of communication implemented at a network device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below:

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the term “TRP” refers to an antenna array (with one or more antenna elements) available to the network device located at a specific geographical location. Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

Generally speaking, one TRP usually corresponds to one SRS resource set. As used herein, the term “single-TRP” refers to that a single SRS resource set is used for performing related transmissions (such as, PUSCH transmissions), and the term “multi-TRP” refers to that a plurality of SRS resource sets are used for performing related transmissions (such as, PUSCH transmissions).

In the following, the terms “PUSCH transmission”, “PUSCH transmission occasion”, “uplink transmission”, “PUSCH repetition”, “PUSCH occasion” and “PUSCH reception” can be used interchangeably. The terms “DCI” and “DCI format” can be used interchangeably: The terms “transmission”, “transmission occasion” and “repetition” can be used interchangeably. The terms “precoder”, “precoding”, “precoding matrix”, “beam”, “spatial relation information”, “spatial relation info”, “TPMI”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter” and “spatial relation” can be used interchangeably. The terms “SRI”, “SRS resource set index”, “UL TCI”, “UL spatial domain filter”, “UL beam”, “joint TCI” can be used interchangeably.

Recently, enhancements on the support for multi-TRP deployment have been discussed. For example, it has been proposed to identify and specify features to improve reliability and robustness for physical channels (such as, Physical Downlink Control Channel (PDCCH), Physical Uplink Shared Channel (PUSCH) and/or Physical Uplink Control Channel (PUCCH)) other than Physical Downlink Shared Channel (PDSCH) using multi-TRP and/or multi-panel with Release 16 reliability features as a baseline. In order to improve reliability and robustness for PUSCH, single or single or multiple DCI(s) can be used to schedule PUSCH transmissions based on multi-TRP and/or multi-panel. It has been agreed that the maximum number of sounding reference signal (SRS) resource sets can be increased to two and two SRS resource indicator fields corresponding to two SRS resource sets can be introduced in DCI which schedules PUSCH transmissions. In addition, two transmission precoding matrix indicator (TPMI) field can be introduced in DCI for scheduling PUSCH transmission. It is further proposed that a dynamic switching between multi-TRP and/or multi-panel and single-TRP should be supported.

From Release-16, for single-DCI based MTRP transmission, PDSCH repetition is supported for better reliability: In Release-17, MTRP repetition is also extended for PUSCH, for both dynamic grant (DG) and configured grant (CG) transmission. According to some technologies, a sequence for Release-16 can be reused for the PUSCH transmission. However, reuse Release-16 implemented new sequences for PUSCH repetition might cause some performance issue. Further, either reusing Release-16 downlink (DL) like new redundancy version (RV) sequences or applying the cyclic shift version for PUSCH repetition might cause some performance issue. According to some technologies, it may add RV sequence shift as dynamic grant PUSCH repetition. However, it does not provide solutions on the initial transmission. According to other technologies, the initial transmission starts also at the first transmission occasion of the second TRP, but it does not consider the RV sequence shift applied to the second TRP and RV₀ may not be at the starting position in the RV sequence. Moreover, in some other technologies, RV sequence is always expected to be mapped started with 0. However, it may waste the transmission occasions before the one associated with RV₀. Moreover, there is no diversity and flexibility to use different RV sequences for transmissions to different TRPs.

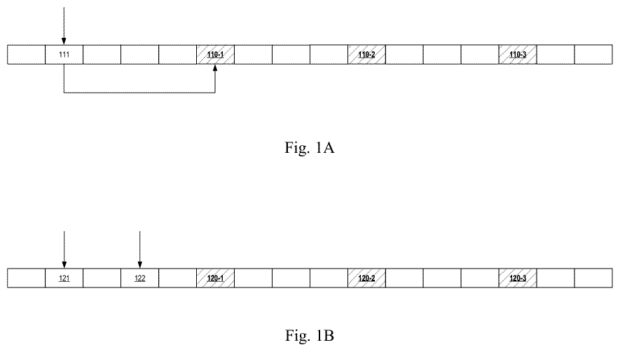

In the uplink, configured grants are used to handle transmissions without a dynamic grant. Two types of configured grants are supported, differing in the ways they are activated (see FIGS. 1A and 1B).

FIG. 1A shows the configured grant type 1, where an uplink grant is provided by RRC, including activation of the grant; and L1/L2 control signaling is used to activate/deactivate the transmission. Type 1 sets all the transmission parameters, including periodicity, time offset, and frequency resources as well as modulation-and-coding scheme of possible uplink transmissions, using RRC signaling. Upon receiving the RRC configuration in slot 111, the device can start to use the configured grant for transmission in the time instant given by the periodicity and offset. The reason for the offset is to control at what time instants the device is allowed to transmit. There is no notion of activation time in the RRC signaling in general: RRC configurations take effect as soon as they are received correctly. This point in time may vary as it depends on whether RLC retransmissions were needed to deliver the RRC command or not. To avoid this ambiguity, a time offset relative to the SFN is included in the configuration. The CG configuration can activate from slot 110-1. The slots 110-1, 110-2 and 110-3 may be possible uplink transmission occasions.

FIG. 1B shows configured grant type 2, where the transmission periodicity is provided by RRC. Type 2 is similar to downlink semi-persistent scheduling. RRC signaling is used to configure the periodicity; while the transmission parameters are provided as part of the activation using the PDCCH. The RRC configuration can be received in slot 121. Upon receiving the PDCCH for activation command in slot 122, the device transmits according to the preconfigured periodicity if there are data in the buffer. If there are no data to transmit, the device will, similar to type 1, not transmit anything. Note that no time offset is needed in this case as the activation time is well defined by the PDCCH transmission instant. The slots 120-1, 120-2 and 120-3 may be possible uplink transmission occasions.

In order to solve at least part of above problems, solutions on redundancy version determination of repeated transmissions are proposed. According to embodiments of the present disclosure, a terminal device receives, from a network device, a radio resource control (RRC) configuration comprising a repetition number for physical uplink shared channel (PUSCH) transmission occasions associated with a first sounding reference signal (SRS) resource indicator (SRI) and PUSCH transmission occasions associated with a second SRI, the RRC configuration further comprises a redundancy version (RV) offset to a RV sequence associated with the first SRI. The terminal device receives DCI indicating an identity of a RV. If a first RV sequence determined based on the repetition number, the identity and the RV offset meets conditions, the terminal device does not apply the first RV sequence. In this way; it improves reliability:

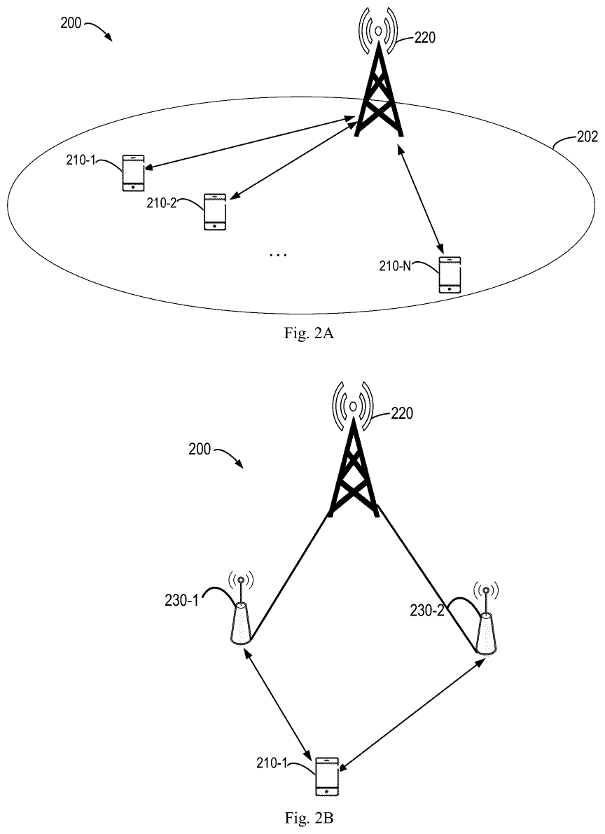

FIG. 2A illustrates an example communication network 200 in which embodiments of the present disclosure can be implemented. The communication system 200, which is a part of a communication network, comprises a terminal device 210-1, a terminal device 210-2, . . . , a terminal device 210-N, which can be collectively referred to as “terminal device(s) 210.” The number N can be any suitable integer number. The communication network 100 includes a network device 220 which serves a terminal device 210. Further, the serving area provided by the network device 220 is called as serving cell 202. The network 200 may provide one or more serving cells 202 to serve the terminal device 210. The terminal device 210 can communicate with the network device 220 via one or more physical communication channels or links.

In the communication network 200, a link from the terminal device 210 to the network device 220 is referred to as an uplink (UL), while a link from the network device 220 to the terminal device 210 is referred to as a downlink (DL). In UL, the terminal device 210 is a TX device (or a transmitter) and the network device 220 is a RX device (or a receiver). In DL, the network device 220 is a transmitting (TX) device (or a transmitter) and the terminal device 210 is a receiving (RX) device (or a receiver).

In the specific example of FIG. 2A, the network device 220 may schedule the UL transmissions (such as, PUSCH transmissions) via such as DCI. In the following text, the example message used for scheduling PUSCH transmissions is discussed with DCI. It is to be understood that a Radio Resource Control (RRC) message/signaling and a Medium Access Control (MAC) control element (CE) message/signaling may also be used for scheduling PUSCH transmissions.

The communications in the communication network 200 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

It is to be understood that the numbers of network devices, terminal devices and/or serving cells are only for the purpose of illustration without suggesting any limitations to the present disclosure. The communication network 200 may include any suitable number of network devices, terminal devices and/or serving cells adapted for implementing implementations of the present disclosure. It would also be appreciated that in some examples, only the homogeneous network deployment or only the heterogeneous network deployment may be included in the communication network 200.

In addition, in order to support multi-TRP and/or multi-panel, the network device 220 may be equipped with one or more TRPs. For example, the network device 220 may be coupled with multiple TRPs in different geographical locations to achieve better coverage. One or more TRPs of the multiple TRPs may be included in a same serving cell or different serving cells. It is to be understood that the TRP can also be a panel, and the panel can also refer to an antenna array (with one or more antenna elements).

FIG. 2B shows an example scenario of the communication network 200 as shown in FIG. 2A. As shown in FIG. 2B, the network device 220 may communicate with the terminal device 210 via TRPs 230-1 and 230-2 (collectively referred to as TRPs 230). In the following text, the TRP 230-1 may be also referred to as the first TRP, while the TRP 230-2 may be also referred to as the second TRP. The first and second TRPs 230-1 and 230-2 may be included in a same serving cell (such as, the serving cell 202 as shown in FIG. 2A) or different serving cells provided by the network device 220.

It is to be understood that the numbers of network devices, terminal devices and/or TRPs are only for the purpose of illustration without suggesting any limitations to the present disclosure. The communication network 200 may include any suitable number of network devices, terminal devices and/or TRPs adapted for implementing implementations of the present disclosure.

In the following text, although some embodiments of the present disclosure are described with reference to two TRPs and the first and second TRPs 230-1 and 230-2 within a same serving cell provided by the network device 220, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

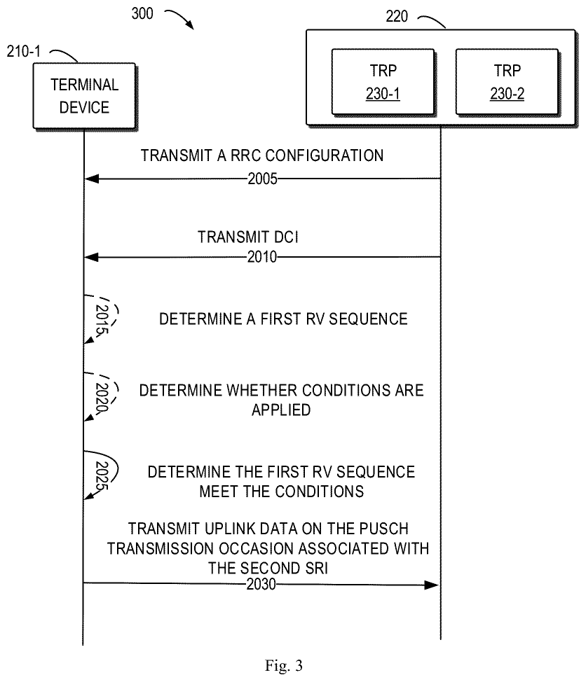

FIG. 3 shows a signaling chart illustrating process 300 among devices according to some example embodiments of the present disclosure. Only for the purpose of discussion, the process 300 will be described with reference to FIG. 2B. The process 300 may involve the terminal device 210-1, the TRP 230-1 and the TRP 230-2. It should be noted that the process 300 is only an example not limitation.

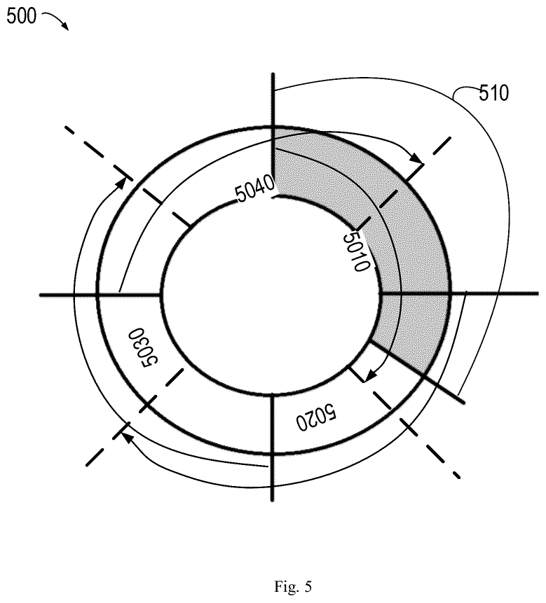

The terminal device 210-1 may be configured with a condition or a set of conditions for PUSCH repetition transmissions to the TRP 230-2. For example, the conditions may indicate that if a RV sequence does not comprise a RV₀ in the first position of the RV sequence, the first RV sequence is not applied. Alternatively or in addition, the conditions may indicate that if the RV sequence comprises no RV₀ in the first and the second positions of the RV sequence, the RV sequence is not applied. In other embodiments, the conditions may indicate that if there are no RV₀ or RV; in the first and second positions of the RV sequence, the RV sequence is not applied. FIG. 5 illustrates a schematic diagram of an example of circular buffer for incremental redundancy. As shown in FIG. 5, the uplink data 500 can comprise a set of systematic bits 510 and check bits. The RV₀ of the uplink data 500 can comprise the set of bits 5010, the RV₁ of the uplink data 500 can comprise the set of bits 5020, the RV₂ of the uplink data 500 can comprise the set of bits 5030, and the RV₃ of the uplink data 500 can comprise the set of bits 5040. Both RV₀ and RV; can be self-decodable since they include more systematic bits. Therefore, it improves reliability of the PUSCH transmissions by applying the conditions.

The network device 220 transmits 2005 a radio resource control (RRC) configuration to the terminal device 210-1. The RRC configuration comprises a repetition number for PUSCH transmission occasion(s) associated with a first SRS indicator (SRI) and PUSCH transmission occasion(s) associated with a second SRI. The PUSCH transmission occasions associated with the first SRI may be used for the TRP 230-1 and the PUSCH transmission occasions associated with the second SRI may be used for the TRP 230-2. Only as an example, if the repetition number indicates 4, it means that the total transmission repetitions for the TRP 230-1 and the TRP 230-2 are 4.

The RRC configuration also comprises a RV offset to a RV sequence associated with the first SRI. The RV offset can be represented as “rvₛ.” The terminal device 210-1 may transmit UE capability report to the network device 220, in order to notify the network its capability: The RRC configuration can be determined based on UE capability reporting. In some embodiments, if the UE capability report indicates that the terminal device 210-1 is capable of enabling conditions of repetition transmissions for the PUSCH transmission occasions associated with the second SRI, the RRC configuration can comprise a first indication to enable conditions of repetition transmissions for the PUSCH transmission occasions associated with the second SRI. For example, the RRC configuration can comprise the parameter “RVRestrictions-secondTRP.” Alternatively or in addition, if the UE capability report indicates that the terminal device 210-1 is capable of shifting RV sequences, the RRC configuration can comprise a second indication to shift a RV sequence for PUSCH transmissions associated with the TRP 130-2. For example, the RRC configuration can comprise the parameter “shiftedToRV0_secondTRP.” Details of shifting the first sequence are described later.

The network device 220 transmits 2010 downlink control information (DCI). The DCI can be used to schedule the PUSCH. The DCI comprises an identity of a RV. The identity of the RV can be represented as “rv_{id}.”

The terminal device 210-1 may determine 2015 the first RV sequence based on the repetition number, the identity and the RV offset. For example, the first RV sequence can be determined based on Table 1 below.

TABLE 1

| rv_{id} indicated | | | | |
|---|---|---|---|---|
| by the DCI | | | | |
| scheduling | rv_{id} to be applied to n^{th} transmission occasion with the second SRI | | | |
| the PUSCH | n mod 4 = 0 | n mod 4 = 1 | n mod 4 = 2 | n mod 4 = 3 |
| 0 | (0 + rvₛ) mod 4 | (2 + rvₛ) mod 4 | (3 + rvₛ) mod 4 | (1 + rvₛ) mod 4 |
| 2 | (2 + rvₛ) mod 4 | (3 + rvₛ) mod 4 | (1 + rvₛ) mod 4 | (0 + rvₛ) mod 4 |
| 3 | (3 + rvₛ) mod 4 | (1 + rvₛ) mod 4 | (0 + rvₛ) mod 4 | (2 + rvₛ) mod 4 |
| 1 | (1 + rvₛ) mod 4 | (0 + rvₛ) mod 4 | (2 + rvₛ) mod 4 | (3 + rvₛ) mod 4 |

For all PUSCH transmission occasions associated with the first TRP 130-1, the redundancy version to be applied is derived according to Table 2 (shown as below), where n is counted only considering PDSCH transmission occasions associated with the first TRP. The redundancy version for PUSCH transmission occasions associated with the second TRP 130-2 is derived according to Table 1, where additional shifting operation for each redundancy version rvₛ is configured by higher layer parameter sequenceOffsetforRV-PUSCH and n is counted only considering PUSCH transmission occasions associated with the second TRP. In other words, the RV sequence associated to the second SRI can be determined by a RV offset from that the selected RV sequence associated to the first SRI. The n starts from 0 to ┌K/2┐−1, where K represents a repetition number and “┌ ┐” represents a ceiling operation.

TABLE 2

| rv_{id} indicated | rv_{id} to be applied to n^{th} transmission occasion | | | |
|---|---|---|---|---|
| by the DCI | (repetition Type A) or n^{th} actual repetition | | | |
| scheduling | (repetition Type B) | | | |
| the PUSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Alternatively, the terminal device 210-1 may determine the first RV sequence based on the formula below.

$$X = {( mod ( mod ( n , 4 ) + r {v}_{s} , 4 ) + 1 )}^{t h} \qquad ( 1 )$$

wherein the X represents the x^{th} value of a RV sequence applied for the first SRI, the rvₛ represents the RV offset to a RV sequence associated with the first SRI and the n represents the n^{th} transmission associated with the second SRI. The value of X can start from 1. In other words, the X can be a positive integer number. Only as an example, if rvₛ equals to 1 and RV_{id} equals to 2, the RV sequence associated with the firs SRI can be {RV₂, RV₃, RV₁, RV₀}. In this situation, when n equals to 0 and x equals to 2, it corresponds to RV₃ according to the formula (1). Similarly, when n equals to 1 and x equals to 3, it corresponds to RV₁. W n equals to 2 and x equals to 4, it corresponds to RV₀. When n equals to 3 and x equals to 1, it corresponds to RV₂. Thus, the first RV sequence can be {RV₃, RV₁, RV₀, RV₂}. The formula (1) can also be represented as “(mod(n+rvₛ, 4)+1)^{th}”. It should be noted that the formula (1) is only an example not limitations.

In other embodiments, the terminal device 210-1 may determine the first RV sequence based on Tables 3-5 below. It should be noted that numbers and values shown in Tables 3-5 are only examples not limitations.

TABLE 3

| rv_{id} indicated | | | | |
|---|---|---|---|---|
| by the DCI | rvₛ = 1, rv_{id} to be applied to n^{th} transmission | | | |
| scheduling | occasion with the second SRI | | | |
| the PUSCH | n mod 4 = 0 | n mod 4 = 1 | n mod 4 = 2 | n mod 4 = 3 |
| 0 | 2 | 3 | 1 | 0 |
| 2 | 3 | 1 | 0 | 2 |
| 3 | 1 | 0 | 2 | 3 |
| 1 | 0 | 2 | 3 | 1 |

TABLE 4

| rv_{id} indicated | | | | |
|---|---|---|---|---|
| by the DCI | rvₛ = 2, rv_{id} to be applied to n^{th} transmission | | | |
| scheduling | occasion with the second SRI | | | |
| the PUSCH | n mod 4 = 0 | n mod 4 = 1 | n mod 4 = 2 | n mod 4 = 3 |
| 0 | 3 | 1 | 0 | 2 |
| 2 | 1 | 0 | 2 | 3 |
| 3 | 0 | 2 | 3 | 1 |
| 1 | 2 | 0 | 1 | 0 |

TABLE 5

| rv_{id} indicated | | | | |
|---|---|---|---|---|
| by the DCI | rvₛ = 3, rv_{id} to be applied to n^{th} transmission | | | |
| scheduling | occasion with the second SRI | | | |
| the PUSCH | n mod 4 = 0 | n mod 4 = 1 | n mod 4 = 2 | n mod 4 = 3 |
| 0 | 1 | 0 | 2 | 3 |
| 2 | 0 | 2 | 3 | 1 |
| 3 | 2 | 3 | 1 | 0 |
| 1 | 3 | 1 | 0 | 2 |

The terminal device 210-1 may determine 2020 whether the set of conditions for PUSCH repetition transmissions to the TRP 230-2 are applied or not. For example, if the number of repetitions associated with the second SRI is less than a predetermined number, the set of conditions can be applied. For example, the predetermined number can be 4. It should be noted that the predetermined number can be any suitable number. Alternatively, if there is a non-acknowledgment (NACK) associated with the TRP 230-2 implied in the DCI, the terminal device 210-1 can apply the set of conditions. In other embodiments, if a non-ideal backhaul between the TRP 230-1 and the TRP 230-2, the set of conditions can be applied. In one embodiment, the term “non-ideal backhaul” means that there is latency and loss between the TRPs or an indication indicating the dynamic switch (e.g. via DCI). As another example embodiment, if there is a dynamic switch from a single TRP to multi TRP, the terminal device 210-1 can apply the set of conditions.

The terminal device 210-1 determines 2025 whether the first RV sequence meets the conditions. For example, the terminal device 210-1 can determine whether the first RV sequence does not comprise a RV₀ in the first position of the RV sequence. Alternatively or in addition, the terminal device 210-1 can determine whether the first RV sequence comprises no RV₀ in the first and the second positions of the RV sequence, the RV sequence is not applied. In other embodiments, the terminal device 210-1 can determine whether the first RV sequence does not comprise RV₀ or RV₃ in the first and second positions of the RV sequence, the RV sequence is not applied.

Only as an example, if the RV offset equals to 3 (i.e., rvₛ), the first RV sequence can be determined based on Table 8 below. Similarly, if the RV offset equals to 1 (i.e., rvₛ), the first RV sequence can be determined based on Table 6 below. If the RV offset equals to 2 (i.e., rvₛ), the first RV sequence can be determined based on Table 7 below. It should be noted that numbers and values shown in Tables 6 to 8 are only examples not limitations.

TABLE 6

| rv_{id} indicated | | | | |
|---|---|---|---|---|
| by the DCI | rvₛ = 1, rv_{id} to be applied to n^{th} transmission | | | |
| scheduling | occasion with the second SRI | | | |
| the PUSCH | n mod 4 = 0 | n mod 4 = 1 | n mod 4 = 0 | n mod 4 = 3 |
| 0 | 1 | 0 | 1 | 0 |
| 2 | 3 | 2 | 3 | 2 |
| 3 | 0 | 3 | 0 | 3 |
| 1 | 2 | 1 | 2 | 1 |

TABLE 7

| rv_{id} indicated | | | | |
|---|---|---|---|---|
| by the DCI | rvₛ = 2, rv_{id} to be applied to n^{th} transmission | | | |
| scheduling | occasion with the second SRI | | | |
| the PUSCH | n mod 4 = 0 | n mod 4 = 1 | n mod 4 = 2 | n mod 4 = 3 |
| 0 | 2 | 0 | 1 | 3 |
| 2 | 0 | 1 | 3 | 2 |
| 3 | 1 | 3 | 2 | 0 |
| 1 | 3 | 2 | 0 | 1 |

TABLE 8

| rv_{id} indicated | | | | |
|---|---|---|---|---|
| by the DCI | rvₛ = 3, rv_{id} to be applied to n^{th} transmission | | | |
| scheduling | occasion with the second SRI | | | |
| the PUSCH | n mod 4 = 0 | n mod 4 = 1 | n mod 4 = 0 | n mod 4 = 3 |
| 0 | 3 | 0 | 3 | 0 |
| 2 | 1 | 2 | 1 | 2 |
| 3 | 2 | 3 | 2 | 3 |
| 1 | 0 | 1 | 0 | 1 |

According to Table 7, if rv_{id} is 2, the first RV sequence is {RV₁, RV₂,RV₀, RV₃}. In this situation, the first RV sequence meets the conditions. Similarly, according to Table 8, if rv_{id} is 1, the first RV sequence is {RV₂, RV₁,RV₃, RV₀}. In this situation, the first RV meets the conditions. The terminal device 210-1 does not expect that the first RV sequence meets the conditions. In other words, the terminal device does not expect to receive the rv_{id} equaling to 2 when configured with rvₛ equals to 3. The terminal device 10 does not expect to receive the rv_{id} equaling to 1 when configured with rvₛ equals to 1. In this case, the network device 220 should avoid transmitting the rv_{id} equaling to 2 when configured with rvₛ equals to 3 or transmitting the rv_{id} equaling to 1 when configured with rvₛ equals to 1. In other words, if configured with higher layer parameter RVRestrictions-secondTRP, then UE does not expect to receive rvid=x when configured with rvₛ=y.

If the first RV sequence meets the conditions, the terminal device 210-1 transmits 2030 uplink data to the network device 220 without applying the first RV sequence. For example, if there is only one PUSCH transmission occasion associated with the second TRP 230-2, the terminal device 210-1 shall always transmit RV₀ of the uplink data.

Alternatively, as mentioned above, the RRC configuration can comprise a second indication to shift a RV sequence for PUSCH transmissions associated with the TRP 130-2. If configured with higher layer parameter shiftedToRV0_secondTRP, and if the terminal device 210-1 receives rv_{id}=x when configured with rvₛ=y, the terminal device 210-1 shall autonomously determines RV sequence as in the row start with RV0. In this situation, if the first RV sequence meets the conditions, the terminal device 210-1 may shift the first RV sequence to a second sequence which does not meet the conditions. For example, according to Table 6, the first RV sequence is {RV₁, RV₂, RV₀, RV₃}. In this case, the terminal device 210-1 can shift the first RV sequence to the second RV sequence which is {RV₀, RV₃, RV₁, RV₂} based on Table 7. Similarly, as another embodiment, according to Table 8, the first RV sequence is {RV₂, RV₁, RV₃, RV₀}. In this case, the terminal device 210-1 can shift the first RV sequence to the second RV sequence which is {RV₀, RV₂, RV₁, RV₃} based on Table 8. In some embodiments, the terminal device 210-1 can transmit uplink data to the network device 220 based on the second RV sequence. Alternatively, the terminal device 210-1 can transmit the RV₀ of uplink data to the network device 220.

In some embodiments, as mentioned above, the terminal device 210-1 may transmit UE capability report to the network device 220, in order to notify the network its capability. For example, the terminal device 210-1 can notify the network that it can determine the RV sequence based on a cyclic shift of a sequence. Only as an example, the formula (1) and Tables 3 to 5 above show examples of cyclic shifting. The terminal device 210-1 can notify the network that it can also determine the RV sequence based on a sequential shift of the sequence. Only as an example, Tables 1, and 6 to 8 above shows examples of sequential shift. In some embodiments, a new higher layer signaling can be added to clarify the ambiguity, for example, RRC parameters SequenceOffsetforRV-v16x0 can be used to indicated that cyclic shift RV sequence is adopted, the candidate values can be the same as for sequenceOffsetforRV. Alternatively, a higher layer parameter can be added to signal whether to adopt the offset for each RV or to adopt the offset to shift RV sequence cyclically, for example shiftOperationRVSequence with candidate values. For example, the offset can be one. It should be noted that the offset can be any suitable number.

In other embodiments, the redundancy version for PUSCH transmission occasions associated with the second TRP can be derived according to (mod(mod(n,4)+rvₛ, 4)+1)th value in the applied RV sequence for the first TRP, where additional shifting operation for each redundancy version rvₛ is configured by higher layer parameter sequenceOffsetforRV-PUSCH and n is counted only considering PUSCH transmission occasions associated with the second TRP. If configured with higher layer parameter RVRestrictions-secondTRP, then if there is only one PUSCH transmission occasion associated with the second TRP, UE shall always transmit RV₀.

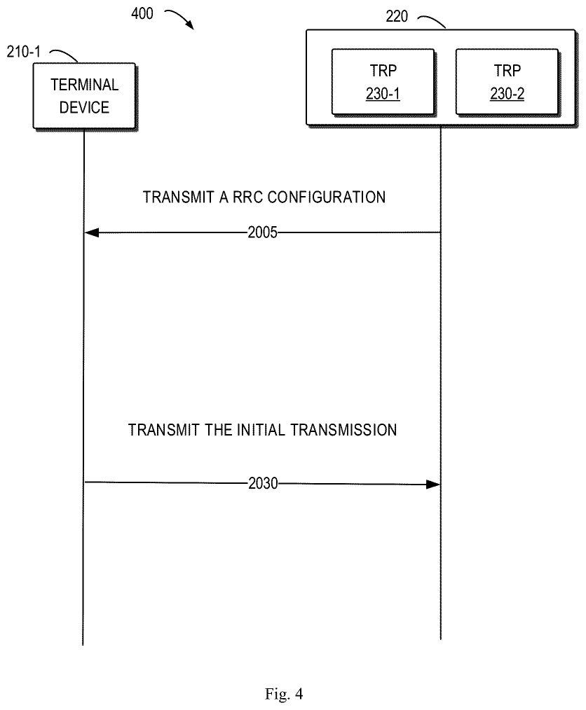

FIG. 4 shows a signaling chart illustrating process 400 among devices according to some example embodiments of the present disclosure. Only for the purpose of discussion, the process 400 will be described with reference to FIG. 2B. The process 400 may involve the terminal device 210-1, the TRP 230-1 and the TRP 230-2. It should be noted that the process 400 is only an example not limitation.

The network device 220 transmits 4005 a RRC configuration to the terminal device 210-1. The RRC configuration comprises a repetition number for PUSCH transmission occasions associated with a first SRS indicator (SRI) and PUSCH transmission occasions associated with a second SRI. The PUSCH transmission occasions associated with the first SRI may be used for the TRP 230-1 and the PUSCH transmission occasions associated with the second SRI may be used for the TRP 230-2. Only as an example, if the repetition number indicates 4, it means that the total transmission repetitions for the TRP 230-1 and the TRP 230-2 are 4.

If a configured grant configuration is configured with startingFromTRP2 set to ‘off’, the initial transmission of a transport block may only start at the first transmission occasion of the K repetitions associated with the first TRP if the configured RV sequence is {0,2,3,1}. Otherwise, besides the first transmission occasion of the K repetitions associated with the first TRP 230-1 if the configured RV sequence is {0,2,3,1}, the initial transmission of a transport block may also start at at (1) the first transmission occasion of the K repetitions associated with the second TRP if the configured RV sequence is {0,2,3,1}, (2) any of the transmission occasions of the K repetitions associated with RV=0 and with the second TRP if the configured RV sequence is {0,2,3,1}. The UE does not transmit the PUSCH in the transmission occasions associated with the first TRP if initial transmission of a transport block starts at a transmission occasions associated with the first TRP. In other embodiments, If a configured grant configuration is configured with startingFromTRP2 set to ‘on’, the initial transmission of a transport block may only start at (1) the first transmission occasion of the K repetitions if the configured RV sequence is {0,2,3,1}, (2) any of the transmission occasions of the K repetitions associated with RV=0 if the configured RV sequence is {0,2,3,1}. In other embodiments, If a configured grant configuration is configured with startingFromTRP2 set to ‘on’, the initial transmission of a transport block may only start at any of the transmission occasions of the K repetitions before the transmission occasion associated with RV=0 if the configured RV sequence is {0,2,3, 1}.

The RRC configuration indicates a set of configured grant parameters. The set of configured grant parameters can indicate which slot(s) are granted. The RRC configuration also comprises an indication to enable an initial transmission associated with the second SRI.

Since more sequences can be configured in CG mode, for example, {RV₀, RV₃, RV₀, RV₃,} and{RV₀, RV₀, RV₀, RV₀,}, different restrictions can be also applied to RV sequence offsets when different RV sequence configured. For example, if the RV sequence for the TRP 230-1 is {RV₀, RV₃, RV₀, RV₃}, the offset for the TRP 230-2 can be 0) or 1. In addition, for CG PUSCH repetition, initial transmission can start also from the first transmission occasion and/or any transmission occasions associated with RV=0 for the second TRP. Regarding the CG PUSCH, the term “PUSCH transmission” used herein can refer to a nominal transmission or refer to an actual transmission.

Tables 9 to 12 show example of CG resources for the TRP 230-1 and the TRP 230-2. As shown in Table 9, the RV sequence for the TRP 230-1 is {RV₀, RV₂, RV₃, RV₁} and the RV sequence of the TRP 230-2 is cyclic shift of the RV sequence for the TRP 230-1. As shown in Table 10, the RV sequence for the TRP 230-1 is {RV₀, RV₂, RV₃, RV₁} and the RV sequence of the TRP 230-2 is cyclic shift of the RV sequence for the TRP 230-1. As shown in Table 11, the RV sequence for the TRP 230-1 is {RV₀, RV₃, RV₀, RV₃} and the RV sequence of the TRP 230-2 is cyclic shift of the RV sequence for the TRP 230-1. As shown in Table 12, the RV sequence for the TRP 230-1 is {RV₀. RV₃. RV₀. RV₃} and the RV sequence of the TRP 230-2 is cyclic shift of the RV sequence for the TRP 230-1.

TABLE 9

| | | Slot | Slot | Slot | Slot | Slot | Slot | Slot | Slot |
|---|---|---|---|---|---|---|---|---|---|
| | | n | m + 1 | m + 2 | m + 3 | m + 4 | m + 5 | m + 6 | m + 7 |
| rvₛ = 0 | to TRP 230-1 | 0 | | 2 | | 3 | | 1 | |
| | to TRP 230-2 | | 0 | | 2 | | 3 | | 1 |
| rvₛ = 1 | to TRP 230-1 | 0 | | 2 | | 3 | | 1 | |
| | to TRP 230-2 | | 2 | | 3 | | 1 | | 0 |
| rvₛ = 2 | to TRP 230-1 | 0 | | 2 | | 3 | | 1 | |
| | to TRP 230-2 | | 3 | | 1 | | 0 | | 2 |
| rvₛ = 3 | to TRP 230-1 | 0 | | 2 | | 3 | | 1 | |
| | to TRP 230-2 | | 1 | | 0 | | 2 | | 3 |

TABLE 10

| | | Slot | Slot | Slot | Slot | Slot | Slot | Slot | Slot |
|---|---|---|---|---|---|---|---|---|---|
| | | n | m + 1 | m + 2 | m + 3 | m + 4 | m + 5 | m + 6 | m + 7 |
| rvₛ = 0 | to TRP 230-1 | 0 | 2 | | | 3 | 1 | | |
| | to TRP 230-2 | | | 0 | 2 | | | 3 | 1 |
| rvₛ = 1 | to TRP 230-1 | 0 | 2 | | | 3 | 1 | | |
| | to TRP 230-2 | | | 2 | 3 | | | 1 | 0 |
| rvₛ = 2 | to TRP 230-1 | 0 | 2 | | | 3 | 1 | | |
| | to TRP 230-2 | | | 3 | 1 | | | 0 | 2 |
| rvₛ = 3 | to TRP 230-1 | 0 | 2 | | | 3 | 1 | | |
| | to TRP 230-2 | | | 1 | 0 | | | 2 | 3 |

TABLE 11

| | | Slot | Slot | Slot | Slot | Slot | Slot | Slot | Slot |
|---|---|---|---|---|---|---|---|---|---|
| | | n | m + 1 | m + 2 | m + 3 | m + 4 | m + 5 | m + 6 | m + 7 |
| rvₛ = 0 | to TRP 230-1 | 0 | | 3 | | 0 | | 3 | |
| | to TRP 230-2 | | 0 | | 3 | | 0 | | 3 |
| rvₛ = 1 | to TRP 230-1 | 0 | | 3 | | 0 | | 3 | |
| | to TRP 230-2 | | 3 | | 0 | | 3 | 0 | |
| rvₛ = 2 | to TRP 230-1 | 0 | | 3 | | 0 | | 3 | |
| | to TRP 230-2 | | 0 | | 3 | | 0 | | 3 |
| rvₛ = 3 | to TRP 230-1 | 0 | | 3 | | 0 | | 3 | |
| | to TRP 230-2 | | 3 | | 0 | | 3 | | 0 |

TABLE 12

| | | Slot | Slot | Slot | Slot | Slot | Slot | Slot | Slot |
|---|---|---|---|---|---|---|---|---|---|
| | | n | m + 1 | m + 2 | m + 3 | m + 4 | m + 5 | m + 6 | m + 7 |
| rvₛ = 0 | to TRP 230-1 | 0 | 3 | | | 0 | 3 | | |
| | to TRP 230-2 | | | 0 | 3 | | | 0 | 3 |
| rvₛ = 1 | to TRP 230-1 | 0 | 3 | | | 0 | 3 | | |
| | to TRP 230-2 | | | 3 | 0 | | | 3 | 0 |
| rvₛ = 2 | to TRP 230-1 | 0 | 3 | | | 0 | 3 | | |
| | to TRP 230-2 | | | 0 | 3 | | | 0 | 3 |
| rvₛ = 3 | to TRP 230-1 | 0 | 3 | | | 0 | 3 | | |
| | to TRP 230-2 | | | 3 | 0 | | | 3 | 0 |

If a PUSCH transmission occasion satisfied a condition, the terminal device 210-1 transmits 4010 the initial transmission to the network device 220. In some embodiments, the PUSCH transmission occasion with the second SRI is associated with RV₀, the terminal device 210-1 can transmits the initial transmission to the TRP 230-2. Alternatively, if the PUSCH transmission occasion with the second SRI is the first transmission occasion of the repetition transmissions, the terminal device 210-1 can transmits the initial transmission to the TRP 230-2. In other embodiments, if the PUSCH transmission occasion with the first SRI is the first transmission occasion of the repetition transmissions, the terminal device 210-1 can transmits the initial transmission to the TRP 230-1.

In some embodiments, if the terminal device 210-1 starts initial transmission at the n^{th} transmission occasion associated with the TRP 230-2, the terminal device 210-1 can terminate the transmission after n+K transmission occasion. The number n is counted considering both the first TRP and the second TRP and n=0, 1, 2 . . . . K−1. The number K represents the repetition number.

In other embodiments, if the terminal device 210-1 starts initial transmission at the nth transmission occasion, the terminal device 210-1 can terminate the transmission after K repetitions. The number n is counted considering both the first TRP and the second TRP and n=0, 1, 2, . . . . K−1. The number K represents the repetition number.

Alternatively, if the terminal device 210-1 starts initial transmission at n^{th} transmission occasion, the terminal device 210-1 can terminate the transmission after K−n+1 repetitions. The number n is counted considering both the first TRP and the second TRP and n=0, 1, 2 . . . , K−1. The number K represents the repetition number.

In some embodiments, for CG PUSCH repetition, initial transmission can start also from the first transmission occasion and/or any transmission occasions associated with RV=0 for the second TRP. In some embodiments, the repetition number may be larger than 8. Alternatively, for non-ideal backhaul and frequency range 2 (FR2), if the initial transmission starts at PUSCH occasion associated with the TRP 230-2, the PUSCH transmission to the TRP 230-1 can be omitted. In this case, the terminal device 210-1 can skip the PUSCH transmission to the TRP 230-1. In this way, it can reduce latency.

In some embodiments, for all PDSCH transmission occasions associated with the first TCI state, the redundancy version to be applied is derived according to Table 13 (below) where n is counted only considering PDSCH transmission occasions associated with the first TCI state. The redundancy version for PDSCH transmission occasions associated with the second TCI state is derived according to (mod(mod(n,4)+rvₛ, 4)+1)^{th} value in the applied RV sequence for the first TCI state, where additional shifting operation for each redundancy version rvₛ is configured by higher layer parameter sequenceOffsetforRV and n is counted only considering PDSCH transmission occasions associated with the second TCI state.

Similarly, In some embodiments, for all PUSCH transmission occasions associated with the first SRI, the redundancy version to be applied is derived according to Table 2 (below) where n is counted only considering PUSCH transmission occasions associated with the first SRI. The redundancy version for PUSCH transmission occasions associated with the second SRI state is derived according to (mod(mod(n,4)+rvₛ, 4)+1)^{th} value in the applied RV sequence for the first SRI state Table 2, where additional shifting operation for each redundancy version rvₛ is configured by higher layer parameter sequenceOffsetfor RV and n is counted only considering PUSCH transmission occasions associated with the second SRI.

Alternatively, for all PDSCH transmission occasions associated with the first TCI state, the redundancy version to be applied is derived according to Table 13 (shown as below), where n is counted only considering PDSCH transmission occasions associated with the first TCI state. The redundancy version for PDSCH transmission occasions associated with the second TCI state is derived according to Table 14 (shown as below), where additional shifting operation for each redundancy version rvₛ is configured by higher layer parameter sequenceOffsetforRV and n is counted only considering PDSCH transmission occasions associated with the second TCI state. The terminal device 210-1 may also transmit to a UE capability report to the network. The UE capability report can indicate that the terminal device 210-1 can support cyclic shifting operation for each redundancy version for PDSCH transmission. If higher layer parameter SequenceOffsetforRV-v16x0 is configured, the redundancy version for PDSCH transmission occasions associated with the second TCI state is derived according to (mod(mod(n,4)+rvₛ, 4)+1)^{th} value in the applied RV sequence for the first TCI state.

TABLE 13

| rv_{id} indicated | | | | |
|---|---|---|---|---|
| by the DCI | rv_{id} to be applied to n^{th} transmission | | | |
| scheduling | occasion with second TCI state | | | |
| the PDSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 14

| rv_{id} indicated | | | | |
|---|---|---|---|---|
| by the DCI | rv_{id} to be applied to n^{th} transmission | | | |
| scheduling | occasion with the second TCI state | | | |
| the PDSCH | n mod 4 = 0 | n mod 4 = 1 | n mod 4 = 2 | n mod 4 = 3 |
| 0 | (0 + rvₛ) mod 4 | (2 + rvₛ) mod 4 | (3 + rvₛ) mod 4 | (1 + rvₛ) mod 4 |
| 2 | (2 + rvₛ) mod 4 | (3 + rvₛ) mod 4 | (1 + rvₛ) mod 4 | (0 + rvₛ) mod 4 |
| 3 | (3 + rvₛ) mod 4 | (1 + rvₛ) mod 4 | (0 + rvₛ) mod 4 | (2 + rvₛ) mod 4 |
| 1 | (1 + rvₛ) mod 4 | (0 + rvₛ) mod 4 | (2 + rvₛ) mod 4 | (3 + rvₛ) mod 4 |

Similarly, for all PUSCH transmission occasions associated with the first SRI, the redundancy version to be applied is derived according to Table 2, where n is counted only considering PUSCH transmission occasions associated with the first SRI. The redundancy version for PUSCH transmission occasions associated with the second SRI is derived according to Table 1, where additional shifting operation for each redundancy version rvₛ is configured by higher layer parameter sequenceOffsetforRV and n is counted only considering PUSCH transmission occasions associated with the second SRI. The terminal device 210-1 may also transmit to a UE capability report to the network. The UE capability report can indicate that the terminal device 210-1 can support cyclic shifting operation for each redundancy version for PUSCH transmission. If higher layer parameter SequenceOffsetforRV-v16x0 is configured, the redundancy version for PUSCH transmission occasions associated with the second SRI is derived according to (mod(mod(n,4)+rvₛ, 4)+1)^{th} value in the applied RV sequence for the first SRI.

Mover, there is no test cases for RV sequence introduced in Table 13, it can replace the conventional test cases (for example, Table 15 below) with following. Further, it should be noted that test case for PDSCH repetition can also be replaced with following.

Redundancy version coding sequence {0,2,3,1} can be updated to one of the following cases: {0,2,3,1}, {0,2,1,3}, {0,1,3,2}, {0,3,1,2}. Particularly for PDSCH repetition, Redundancy version coding sequence {0,2,3,1} can be updated to one of the following cases: the first TCI state {0,2,3,1}, the second TCI state {0,2,3,1}, the first TCI state {0,2,3,1}, the second TCI state {1,3,0,2}, the first TCI state {0,2,3,1}, the second TCI state {2,0,1,3}, the first TCI state {0,2,3,1}, the second TCI state {3,1,2,0}.

Particularly for PUSCH repetition, Redundancy version coding sequence {0,2,3,1} can be updated to one of the following cases: the first SRI {0,2,3,1}, the second SRI {0,2,3,1}, the first SRI {0,2,3,1}, the second SRI {1,3,0,2}, the first SRI {0,2,3,1}, the second SRI {2,0,1,3}, the first SRI {0,2,3,1}, the second SRI {3,1,2,0}. The terminal device 210-1 can perform the uplink transmission based on the above RV sequenc.

The performance requirement of PUSCH is determined by a maximum block error probability (BLER) for a given SNR. The BLER is defined as the probability of incorrectly decoding the PUSCH information when the PUSCH information is sent. The performance requirements assume HARQ re-transmissions. Table 15 below shows test parameters for testing PUSCH repetition Type A.

TABLE 15

| Parameter | | Value |
|---|---|---|
| Transform precoding | | Disabled |
| Default TDD UL-DL pattern (Note 1) | | 15 kHz SCS: |
| | | 3D1S1U, |
| | | S = 10D:2G:2U |
| | | 30 kHz SCS: |
| | | 7D1S2U, |
| | | S = 6D:4G:4U |
| HARQ | Maximum number of HARQ transmissions | 4 |
| | RV sequence | 0, 3, 0, 3 [Note 2] |
| DM-RS | DM-RS configuration type | 1 |
| | DM-RS duration | single-symbol |
| | | DM-RS |
| | Additional DM-RS position | pos1 |
| | Number of DM-RS CDM group(s) without data | 2 |
| | Ratio of PUSCH EPRE to DM-RS EPRE | −3 dB |
| | DM-RS port | 0 |
| | DM-RS sequence generation | N_{ID}⁰ = 0, n_{SCID} = 0 |
| Time domain | PUSCH mapping type | A, B |
| resource | Start symbol | 0 |
| assignment | Allocation length | 14 |
| | PUSCH aggregation factor | 30 kHz SCS: n2 |
| | | 15 kHz SCS: n2 for |
| | | FDD and n8 for |
| | | TDD [Note 3] |
| Frequency | RB assignment | Full applicable test |
| domain resource | | bandwidth |
| assignment | Frequency hopping | Disabled |

| | |
|---|---|
| Code block group based PUSCH transmission | Disabled |

(Note 1):
The same requirements are applicable to FDD and TDD with different UL-DL pattern.
[Note 2]:
In a scenario of slot aggregation, the RV sequence {0, 2, 3, 1} is used instead of {0, 3, 0, 3}.
[Note 3]:
The intention of this configuration is to have two effective transmissions of the transport block. To achieve this for the standard TDD pattern captured in this table, a value of n8 is necessary, while for FDD a value of n2 is necessary.

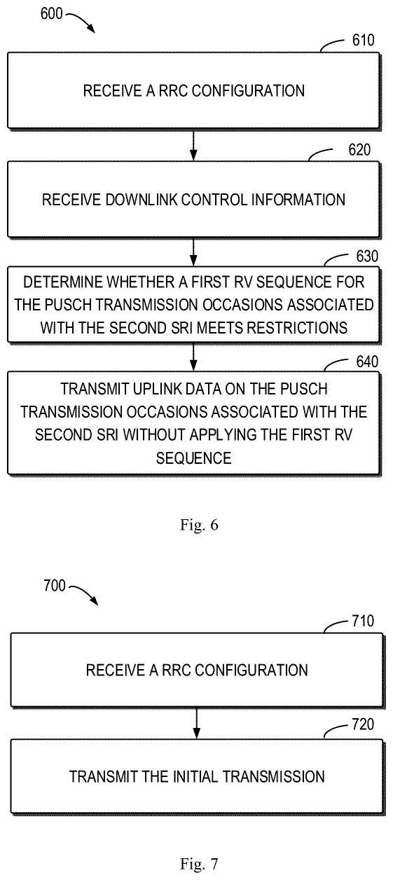

FIG. 6 shows a flowchart of an example method 600 in accordance with an embodiment of the present disclosure. Only for the purpose of illustrations, the method 600 can be implemented at a terminal device 210-1 as shown in FIGS. 2A and 2B.

At block 610, the terminal device 210-1 receives from the network device 220, a radio resource control (RRC) configuration. The RRC configuration comprises a repetition number for physical uplink shared channel (PUSCH) transmission occasions associated with a first sounding reference signal (SRS) resource indicator (SRI) and PUSCH transmission occasions associated with a second SRI. The RRC configuration further comprises a redundancy version (RV) offset to a RV sequence associated with the first SRI. In some embodiments, the RRC configuration can comprise a first indication to enable the conditions. Alternatively, the RRC configuration further can comprise a second indication to enable shift the first RV sequence.

At block 620, the terminal device 210-1 receives, from the network device 220, downlink control information (DCI) indicating an identity of a RV:

At block 630, the terminal device 210-1 determines whether a first RV sequence for the PUSCH transmission occasions associated with the second SRI meets a condition of repetition transmissions for the PUSCH transmission occasions associated with the second SRI, the first RV sequence being determined based on the repetition number, the identity and the RV offset.

In some embodiments, the condition indicates that the first RV sequence is not applied in accordance with a determination that one of the followings is met: the first RV sequence comprises no RV0 in the first position of the first RV sequence, the first RV sequence comprises no RV0 in the first and second positions of the first RV sequence, or the first RV sequence comprises no RV0 or RV₃ in the first and second positions of the first RV sequence.

In some embodiments, the terminal device 210-1 can apply the condition if at least one of the following is met: a number of repetitions associated with the second SRI is less than a predetermined number, for example, 4, a non-acknowledgement implied in the DCI, a non-ideal backhaul between a first transmission point associated with the first SRI and a second transmission point associated with the second SRI, or a dynamic switch from a single transmission point to multi transmission point. It should be noted that the predetermined number can be any suitable number.

In other embodiments, the terminal device 210-1 can determine the first RV sequence based on the repetition number, the identity and a predetermined table. Alternatively, the terminal device 210-1 can determine the first RV sequence based on the repetition number, the identity and a formula (shown as formula 1 above).

At block 640, in accordance with a determination that the first RV sequence meets the conditions, the terminal device 210-1 transmits, to the network device 220, uplink data on the PUSCH transmission occasions associated with the second SRI without applying the first RV sequence. In some embodiments, if there is only one PUSCH transmission occasion associated with the second SRI, the terminal device 210-1 can transmit the RV0 of the uplink data on the PUSCH transmission associated with the second SRI. Alternatively, the terminal device 210-1 can transmit RV0 of the uplink data on the PUSCH transmission associated with the second SRI.

FIG. 7 shows a flowchart of an example method 700 in accordance with an embodiment of the present disclosure. Only for the purpose of illustrations, the method 700 can be implemented at a terminal device 210-1 as shown in FIGS. 2A and 2B.

At block 710, the terminal device 210-1 receives from the network device 220 a radio resource control (RRC) configuration. The RRC configuration comprises: a repetition number for repetition transmissions of physical uplink shared channel (PUSCH) transmission occasions associated with a first sounding reference signal (SRS) resource indicator (SRI) and PUSCH transmission occasions associated with a second SRI, a set of configured grant parameters, and an indication to enable an initial transmission associated with the second SRI.

At block 720, the terminal device 210-1 transmits the initial transmission if a PUSCH transmission occasion satisfies a condition. The conditions can comprise one of: the PUSCH transmission occasion with the second SRI is associated with RV₀, the PUSCH transmission occasion with the second SRI is the first transmission occasion of the repetition transmissions, or the PUSCH transmission occasion with the first SRI is the first transmission occasion of the repetition transmissions.

In other embodiments, if the initial transmission is associated with the second SRI, the terminal device 210-1 may skip PUSCH transmission associated with the first SRI.

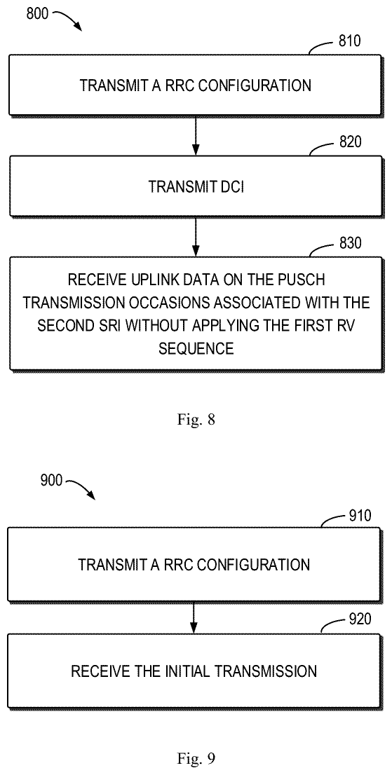

FIG. 8 shows a flowchart of an example method 800 in accordance with an embodiment of the present disclosure. Only for the purpose of illustrations, the method 800 can be implemented at a network device 220 as shown in FIGS. 2A and 2B.

At block 810, the network device 220 transmits, to the terminal device 210-1, a radio resource control (RRC) configuration. The RRC configuration comprises a repetition number for physical uplink shared channel (PUSCH) transmission occasions associated with a first sounding reference signal (SRS) resource indicator (SRI) and PUSCH transmission occasions associated with a second SRI. The RRC configuration further comprises a redundancy version (RV) offset to a RV sequence associated with the first SRI, and a redundancy version (RV) offset to a RV sequence associated with the first SRI. In some embodiments, the RRC configuration can comprise a first indication to enable the conditions. Alternatively, the RRC configuration further can comprise a second indication to enable shift the first RV sequence.

At block 820, the network device 220 transmits, to the terminal device 210-1, downlink control information (DCI) indicating an identity of a RV.

At block 830, in accordance with a determination that a first RV sequence determined based on the repetition number and the identity meets conditions of repetition transmissions for the PUSCH transmission occasions associated with the second SRI, the network device 220 receives, from the terminal device 210-1, uplink data on the PUSCH transmission occasions associated with the second SRI without applying the first RV sequence.

In some embodiments, the condition indicates that the first RV sequence is not applied in accordance with a determination that one of the followings is met: the first RV sequence comprises no RV0 in the first position of the first RV sequence, the first RV sequence comprises no RV0 in the first and second positions of the first RV sequence, or the first RV sequence comprises no RV0 or RV3 in the first and second positions of the first RV sequence.

In some embodiments, if there is only one PUSCH transmission occasion associated with the second SRI, the network device 220 can receive the RV0 of the uplink data on the PUSCH transmission occasions associated with the second SRI. In other embodiments, the network device 220 can receive the uplink data on the PUSCH transmission associated with the second SRI based on a second RV sequence which is determined by shifting the first RV sequence.

FIG. 9 shows a flowchart of an example method 900 in accordance with an embodiment of the present disclosure. Only for the purpose of illustrations, the method 900 can be implemented at a network device 220 as shown in FIGS. 2A and 2B.

At block 910, the network device 220 transmits to the terminal device 210-1 a radio resource control (RRC) configuration. The RRC configuration comprises: a repetition number for repetition transmissions of physical uplink shared channel (PUSCH) transmission occasions associated with a first sounding reference signal (SRS) resource indicator (SRI) and PUSCH transmission occasions associated with a second SRI, a set of configured grant parameters, and an indication to enable an initial transmission associated with the second SRI.

At block 720, the network device 220 receives the initial transmission if a PUSCH transmission occasion satisfies a condition. The conditions can comprise one of: the PUSCH transmission occasion with the second SRI is associated with RV₀, the PUSCH transmission occasion with the second SRI is the first transmission occasion of the repetition transmissions, or the PUSCH transmission occasion with the first SRI is the first transmission occasion of the repetition transmissions.

In some embodiments, a terminal device comprises circuitry configured to receive, at a terminal device and from a network device, a radio resource control (RRC) configuration comprising a repetition number for physical uplink shared channel (PUSCH) transmission occasions associated with a first sounding reference signal (SRS) resource indicator (SRI) and PUSCH transmission occasions associated with a second SRI, the RRC configuration further comprising a redundancy version (RV) offset to a RV sequence associated with the first SRI: receive, from the network device, downlink control information (DCI) indicating an identity of a RV: determine whether a first RV sequence for the PUSCH transmission occasions associated with the second SRI meets a condition of repetition transmissions for the PUSCH transmission occasions associated with the second SRI, the first RV sequence being determined based on the repetition number, the identity and the RV offset; and in accordance with a determination that the first RV sequence meets the condition, transmit, to the network device, uplink data on the PUSCH transmission occasions associated with the second SRI without applying the first RV sequence.

In some embodiments, the condition indicates that the first RV sequence is not applied in accordance with a determination that one of the followings is met: the first RV sequence comprises no RV₀ in the first position of the first RV sequence, the first RV sequence comprises no RV₀ in the first and second positions of the first RV sequence, or the first RV sequence comprises no RV0 or RV3 in the first and second positions of the first RV sequence.

In some embodiments, the RRC configuration further comprises a first indication to enable the conditions.

In some embodiments, the terminal device comprises circuitry configured to transmit the uplink data on the PUSCH transmission occasions associated with the second SRI without applying the first RV sequence by in accordance with a determination that there is only one PUSCH transmission occasion associated with the second SRI, transmitting the RV0 of the uplink data on the PUSCH transmission associated with the second SRI.

In some embodiments, the RRC configuration further comprises a second indication to enable shift the first RV sequence.

In some embodiments, the terminal device comprises circuitry configured to transmit the uplink data on the PUSCH transmission occasions associated with the second SRI by transmitting RV0 of the uplink data on the PUSCH transmission associated with the second SRI.

In some embodiments, the terminal device comprises circuitry configured to determine the first RV sequence based on the repetition number, the identity and a predetermined table: or determine the first RV sequence based on the repetition number, the identity and a formula as below:

$$X = {( mod ( mod ( n , 4 ) + r {v}_{s} , 4 ) + 1 )}^{t h}$$

wherein the X represents the x^{th} value of a RV sequence applied for the first SRI, the rvₛ represents the RV offset to a RV sequence associated with the first SRI and the n represents the nth transmission associated with the second SRI.

In some embodiments, the terminal device comprises circuitry configured to apply the conditions in accordance with a determination that at least one of the following is met: a number of repetitions associated with the second SRI is less than 4, a non-acknowledgement implied in the DCI, a non-ideal backhaul between a first transmission point associated with the first SRI and a second transmission point associated with the second SRI, or a dynamic switch from a single transmission point to multi transmission point.

In some embodiments, a terminal device comprises circuitry configured to receive, at a terminal device and from a network device, a radio resource control (RRC) configuration comprising: a repetition number for repetition transmissions of physical uplink shared channel (PUSCH) transmission occasions associated with a first sounding reference signal (SRS) resource indicator (SRI) and PUSCH transmission occasions associated with a second SRI, a set of configured grant parameters, and an indication to enable an initial transmission associated with the second SRI: in accordance with a determination that a PUSCH transmission occasion satisfies a condition, transmitting, to the network device, the initial transmission.

In some embodiments, the conditions indicates that the first RV sequence is not applied in accordance with a determination that one of the followings is met: the first RV sequence comprises no RV₀ in the first position of the first RV sequence, the first RV sequence comprises no RV₀ in the first and second positions of the first RV sequence, or the first RV sequence comprises no RV0 or RV3 in the first and second positions of the first RV sequence.

In some embodiments, the terminal device comprises circuitry configured to in accordance with a determination that the initial transmission is associated with the second SRI, cause PUSCH transmission associated with the first SRI to be skipped.

In some embodiments, a network device comprises circuitry configured to transmit, to a terminal device, a radio resource control (RRC) configuration comprising a repetition number for physical uplink shared channel (PUSCH) transmission occasions associated with a first sounding reference signal (SRS) resource indicator (SRI) and PUSCH transmission occasions associated with a second SRI, the RRC configuration further comprising a redundancy version (RV) offset to a RV sequence associated with the first SRI, and a redundancy version (RV) offset to a RV sequence associated with the first SRI; transmit, to the terminal device, downlink control information (DCI) indicating an identity of a RV; and in accordance with a determination that a first RV sequence determined based on the repetition number and the identity meets conditions of repetition transmissions for the PUSCH transmission occasions associated with the second SRI, receive, from the terminal device, uplink data on the PUSCH transmission occasions associated with the second SRI without applying the first RV sequence.

In some embodiments, the conditions indicates that the first RV sequence is not applied in accordance with a determination that one of the followings is met: the first RV sequence comprises no RV₀ in the first position of the first RV sequence, the first RV sequence comprises no RV₀ in the first and second positions of the first RV sequence, or the first RV sequence comprises no RV0 or RV3 in the first and second positions of the first RV sequence.

In some embodiments, the RRC configuration further comprises a first indication to enable the conditions.

In some embodiments, the network device comprises circuitry configured to receive the uplink data on the PUSCH transmission occasions associated with the second SRI without applying the first RV sequence by: in accordance with a determination that there is only one PUSCH transmission occasion associated with the second SRI, receiving the RV0 of the uplink data on the PUSCH transmission occasions associated with the second SRI.

In some embodiments, the RRC configuration further comprises a second indication to enable shift the first RV sequence.

In some embodiments, the network device comprises circuitry configured to receive the uplink data on the PUSCH transmission associated with the second SRI without applying the first RV sequence by: receiving the uplink data on the PUSCH transmission associated with the second SRI based on a second RV sequence which is determined by shifting the first RV sequence.

In some embodiments, a network device comprises circuitry configured to transmit, at a network device and to a terminal device, a radio resource control (RRC) configuration comprising: a repetition number for physical uplink shared channel (PUSCH) transmission occasions associated with a first sounding reference signal (SRS) resource indicator (SRI) and PUSCH transmission occasions associated with a second SRI, a set of configured grant parameters, and an indication to enable an initial transmission associated with the second SRI; and in accordance with a determination that a PUSCH transmission occasion satisfies a condition, receive, from the terminal device, the initial transmission.

In some embodiments, the conditions indicates that the first RV sequence is not applied in accordance with a determination that one of the followings is met: the first RV sequence comprises no RV₀ in the first position of the first RV sequence, the first RV sequence comprises no RV₀ in the first and second positions of the first RV sequence, or the first RV sequence comprises no RV0 or RV3 in the first and second positions of the first RV sequence.

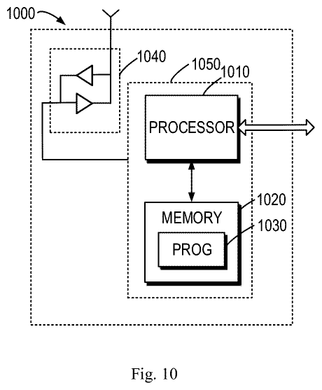

FIG. 10 is a simplified block diagram of a device 1000 that is suitable for implementing embodiments of the present disclosure. The device 1000 can be considered as a further example implementation of the network device 220, or the terminal device 210 as shown in FIGS. 2A and 2B. Accordingly, the device 1000 can be implemented at or as at least a part of the terminal device 210, or the network device 220.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIGS. 3 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server. The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-22. (canceled)

23. A communication method performed by a terminal device, the method comprising:
receiving from a network device, in a radio resource control (RRC) message, configuration information comprising:
a number of repetitions K for Physical Uplink Shared Channel (PUSCH) repetition corresponding to transmission occasions associated with a first sounding reference signal (SRS) resource set and a second SRS resource set; and
an indication being set to either ‘on’ or ‘off’, wherein,
the indication being set to ‘off’ indicates that a first initial transmission of a transport block may only start at a first transmission occasion, corresponding to the first SRS resource set, of the K repetitions, and
the indication being set to ‘on’ indicates that a second initial transmission of a transport block may start at a first transmission occasion associated with RV=0 corresponding to the first SRS resource set or the second SRS resource set of the K repetitions if an RV sequence configured for the terminal device is {0,2,3,1}; and
transmitting, to the network device, either the first initial transmission or the second initial transmission based on the indication.

24. The method of claim 23, wherein the RV sequence configured for the terminal device is {0,2,3,1}, and the first transmission occasion associated with RV=0 corresponds to the second SRS resource set.

25. The method of claim 23, further comprising:
being configured with a parameter indicating an RV sequence.

26. The method of claim 23, wherein an RV sequence configured to the terminal device corresponds to an nth actual repetition, for repetition type B.

27. A communication method performed by a network device, the method comprising:
transmitting to a terminal device, in a radio resource control (RRC) message, configuration information comprising:
a number of repetitions K for Physical Uplink Shared Channel (PUSCH) repetition corresponding to transmission occasions associated with a first sounding reference signal (SRS) resource set and a second SRS resource set; and
an indication being set to either ‘on’ or ‘off’, wherein,
the indication being set to ‘off’ indicates that a first initial transmission of a transport block may only start at a first transmission occasion, corresponding to the first SRS resource set, of the K repetitions, and
the indication being set to ‘on’ indicates that a second initial transmission of a transport block may start at a first transmission occasion associated with RV=0 corresponding to the first SRS resource set or the second SRS resource set of the K repetitions if an RV sequence configured for the terminal device is {0,2,3,1}; and
receiving, from the terminal device, either the first initial transmission or the second initial transmission based on the indication.

28. The method of claim 27, wherein the RV sequence configured for the terminal device is {0,2,3,1}, and the first transmission occasion associated with RV=0 corresponds to the second SRS resource set.

29. The method of claim 27, further comprising:
configuring a parameter indicating an RV sequence.

30. The method of claim 27, wherein an RV sequence configured to the terminal device corresponds to an nth actual repetition, for repetition type B.

31. A terminal device, comprising:
a receiver configured to receive from a network device, in a radio resource control (RRC) message, configuration information comprising:
a number of repetitions K for Physical Uplink Shared Channel (PUSCH) repetition corresponding to transmission occasions associated with a first sounding reference signal (SRS) resource set and a second SRS resource set; and
an indication being set to either ‘on’ or ‘off’, wherein,
the indication being set to ‘off’ indicates that a first initial transmission of a transport block may only start at a first transmission occasion, corresponding to the first SRS resource set, of the K repetitions, and
the indication being set to ‘on’ indicates that a second initial transmission of a transport block may start at a first transmission occasion associated with RV=0 corresponding to the first SRS resource set or the second SRS resource set of the K repetitions if an RV sequence configured for the terminal device is {0,2,3,1}; and
a transmitter configured to transmit, to the network device, either the first initial transmission or the second initial transmission based on the indication.

32. The terminal device of claim 31, wherein the RV sequence configured for the terminal device is {0,2,3,1}, and the first transmission occasion associated with RV=0 corresponds to the second SRS resource set.

33. The terminal device of claim 31, further comprising:
being configured with a parameter indicating an RV sequence.

34. The terminal device of claim 31, wherein an RV sequence configured to the terminal device corresponds to an nth actual repetition, for repetition type B.
